(19) United States
(12) Patent Application Publication
(10) Pub. No.: US 2022/0128145 A1
(43) Pub. Date: Apr. 28, 2022

(54) Actuator Unit

(71) Applicant: KNORR-BREMSE Systeme füer Nutzfahrzeuge GmbH, Muenchen (DE)

(72) Inventor: Daniel GEIS-ESSER, Muenchen (DE)

(21) Appl. No.: 17/423,383

(22) PCT Filed: Jan. 14, 2020
(86) PCT No.: PCT/EP2020/050800

§ 371 Date: Jul. 15, 2021

(30) Foreign Application Priority Data
Jan. 16, 2019 (DE) 10 2019 200 498.9

(51) Int. Cl. F16H 61/32; F16H 61/30; F16H 63/30

(52) U.S. Cl. CPC F16H 61/32; F16H 61/30; F16H 2061/326; F16H 63/3023; F16H 2200/0021; F16H 63/304

(57) ABSTRACT

An actuator unit for a shiftable transmission, in particular a transmission of an electrically driven utility vehicle, has an actuating element which is designed to adjust at least two shift positions in the transmission. The actuator unit is designed to be provided as a separate unit at least partially within the transmission. A transmission having such an actuator unit is disclosed.

### BACKGROUND AND SUMMARY OF THE INVENTION

The present invention relates to an actuator unit for a transmission, and to a transmission having such an actuator unit.

Transmissions are shifted by means of one activation element or a plurality of activation elements which is/are brought to engage with shifting elements of the transmission and deflect the latter. A deflection of a shifting element to a shifting position here has the effect that a rotationally fixed connection, for example between a gear wheel and a shaft, is established or released again. Accordingly, a gear of the transmission is engaged or disengaged again. The shifting element usually contacts further elements of the transmission, for example a shifting collar. When no gear is engaged, the shifting element is situated in a neutral shifting position, thus a neutral position.

The term “shifting element” here is to be understood to represent all elements of a transmission which are configured for engaging or disengaging, respectively, a gear of the transmission. For example, a shifting element is adjoined by a linkage which connects the shifting element to a shifting fork, the latter ultimately being configured for displacing the shifting collar. However, other embodiments of transmissions which permit direct access to the shifting forks, for example, are also contemplated. Furthermore, transmissions of which the shifting elements do not have any shifting forks can be provided. Shifting forks and linkages hereunder are likewise to be understood to be shifting elements. Therefore, the term “shifting element” hereunder is to be understood as a generic term for these elements.

Moreover, information pertaining to whether a shifting element is disengaged is advantageous in order for this information to be further processed, for example within a transmission control unit.

In the case of present transmissions, all of the components which implement the functions described above are provided separately, or disposed at different positions, respectively, this impeding simple assembling or disassembling. These disadvantages can be perceived above all when planning the assembly or pre-assembly, the latter not taking place at the same location as the final assembly, for example.

It is therefore an object of the present invention to provide an actuator unit for a transmission which has all functionalities described above and at the same time solves the issue described above. Furthermore, a transmission having such an actuator unit is to be made available.

This object is achieved by the subject matter of the independent claims. Advantageous refinements are the subject matter of the dependent claims.

Provided according to the invention is an actuator unit for a shiftable transmission, having:

an activation element which is configured for setting at least two shifting positions in the transmission, wherein the actuator unit is configured for being provided at least in part as a separate unit within the transmission.

The actuator unit is preferably configured for a transmission of an electrically driven commercial vehicle.

The actuator unit is preferably configured so as to be positionable in or on the transmission such that the activation element extends into the interior of the transmission. Further parts of the actuator unit here can be situated outside the transmission. The entire actuator unit is particularly preferably provided within the transmission.

The activation element for setting the at least two shifting positions is preferably configured for engaging with at least one shifting element of the transmission. The engagement can furthermore preferably be configured as a permanent engagement, as a result of which a displacement of the activation element always has the effect of influencing the shifting element, preferably effecting a displacement or deflection of the shifting element.

The activation element is furthermore preferably configured for being displaced parallel to an activation direction.

The actuator unit can thus be provided as a separate component in a transmission, wherein installation and removal for the purposes of assembly or maintenance is facilitated because only one component is affected.

The activation element is preferably configured so as to be integral to the at least one shifting element. As a result, a further integration of components of the transmission in the actuator unit can be achieved. For example, the activation element is configured so as to be integral to a shifting fork, the latter communicating with a corresponding shifting collar of the transmission or any other shifting element and preferably engaging therewith.

The actuator unit preferably has a housing which is configured for being provided in or on the transmission. The housing is preferably configured for being fastened in or to the transmission by means of fasteners, for example by means of screws. Furthermore preferably, the housing of the actuator unit per se can have connecting elements which are configured for contacting correspondingly communicating connecting elements of the transmission, preferably connecting elements of the housing of the transmission, so as to achieve that the actuator unit is fixed or at least aligned within the transmission. Connections configured by connecting elements of this type can be embodied as tongue-and-groove connections, for example.

The transmission is preferably configured for an electrically driven vehicle, preferably for a commercial vehicle.

One of the at least two shifting positions preferably comprises a neutral position or a reverse gear of the transmission. In one preferred embodiment, the transmission is provided as a two-speed transmission, wherein two shifting positions are configured as forward gears, thus as a first and a second gear, or as a forward and a reverse gear, a third shifting position which is configured as a neutral position being provided.

The actuator unit preferably has an actuator which is configured for displacing the activation element parallel to the activation direction.

The actuator is preferably configured as a fluidic actuator, in particular as a pneumatic or hydraulic actuator. Alternatively, the actuator is preferably configured as an electromechanical or motorized actuator. The power supply to the actuator unit, or to the actuator, respectively, in terms of construction can thus be readily implemented by a corresponding design of the routing of lines, since corresponding fluidic lines or lines for supplying an electric current can be readily routed in available intermediate spaces.

Preferably, in a fluidic configuration, in particular in a pneumatic or hydraulic configuration, of the actuator, actuating members which are configured for activating the actuator are provided within the actuator unit, preferably within the housing of the actuator unit. Actuating members of this type are for example solenoid valves which are configured for controlling the fluid flow.

The actuator unit preferably has at least one control unit which is configured for controlling the actuator unit.

The actuator unit preferably has at least one detection unit which is configured for detecting a position of the activation element along the activation direction.

The at least one control unit is preferably configured as an electronic control means. Such a control unit can preferably have an electronic control apparatus which is configured for controlling the actuator unit.

The at least one detection unit is preferably configured as a path sensor. A path sensor of this type can be present in any known embodiment. For example, this sensor can operate according to an electromagnetic principle. The sensor is particularly preferably configured as a Hall sensor. Alternatively, a movement of a further element, for example a rotating movement, can be initiated by the displacement of the activation element by way of a mechanical coupling. This rotating movement preferably increments a counter, particular preferably in the control means, such that the position of the activation element can be derived from the value of the counter.

The detection unit is preferably configured so as to be integral to the control means. As a result, a compact construction mode is advantageously enabled such that the actuator unit overall can be configured in a compact construction.

The actuator unit preferably has at least one signal interface which is configured for receiving a control signal and/or emitting a status signal. The control signal is preferably configured for communicating a nominal shifting position to the control means. The control unit per se is furthermore preferably configured for determining a present shifting position from the control signal, particularly preferably from the nominal shifting position and the position of the activation element along the activation direction, and for accordingly actuating the actuator in order for the present shifting position to be adapted to the nominal shifting position. The status signal preferably contains information pertaining to an existing actual shifting position. This information can be processed by further processing means outside the transmission.

If no control unit is provided in the actuator unit, the control signal received is preferably configured for actuating the actuator within the actuator unit and/or further elements for the operation of the actuator unit.

The at least one signal interface is preferably configured for relaying information which is obtained within the actuator unit, for example by a detection unit or by a control means, to a further element within or outside the actuator unit. A shifting position or a position of the activation element can be transmitted as such information, for example.

The signal interface is preferably configured for establishing a connection to a vehicle network such as a CAN-BUS, or to a superordinate entity such as a transmission control apparatus.

The actuator unit preferably has at least one power interface which is configured for receiving power for the operation of the actuator unit.

The at least one signal interface for receiving the control signal is preferably configured for establishing a connection to an element outside a housing of the transmission. The at least one signal interface of the actuator unit is preferably configured for extending through the transmission housing, for example through an opening of the transmission housing.

The at least one power interface for receiving the power is preferably configured for establishing a connection to an element outside the housing of the transmission. The at least one power interface of the actuator unit is preferably configured for extending through the transmission housing, for example through an opening of the transmission housing.

The activation direction is preferably configured as a straight line or as a circular path. In general, configurations of the activation direction which have both circular as well as straight elements can also be provided.

The actuator unit, in particular the housing, in relation to a transmission preferably has an assembly alignment. This means that the side of the housing by way of which the latter is assembled in the transmission, preferably in the transmission housing, has a geometry which is in particular not symmetrical with respect to a point. At the same time, a side of the transmission on which the actuator unit is assembled also has such a complementary geometry, wherein both geometries have to be brought to engage in order to be assembled, to which end the actuator unit and the transmission have to be mutually aligned in a corresponding manner. Assembly of the actuator unit on the transmission is thus precluded when the housing is wrongly aligned.

Alternatively or additionally, the actuator unit in relation to the transmission, preferably in relation to the transmission housing, can have a positioning. A positioning preferably has positioning pins and/or centering pins. Said positioning pins and/or centering pins are configured in such a manner that the latter permit the actuator unit to be assembled only in one specific alignment on the transmission. To this end, the positioning pins or centering pins, respectively, which are preferably provided on the actuator unit and/or on the transmission have to be introduced into corresponding openings on the transmission and/or on the actuator unit in order to ensure flawless assembling.

The assembly alignment and/or the positioning are/is preferably configured for engaging with an assembly alignment and/or positioning of the transmission.

Furthermore provided according to the invention is a transmission which has an assembly portion configured for assembling an actuator unit according to the invention.

The assembly portion preferably has an assembly alignment and/or a positioning in relation to an actuator unit described above. The assembly portion and/or the positioning are/is configured so as to correspondingly communicate with an assembly portion and/or a positioning of an actuator unit. The transmission is thus configured for preventing any erroneous assembly of an actuator unit.

The transmission furthermore has at least two shifting positions. One of the at least two shifting positions preferably comprises a neutral position or a reverse gear of the transmission. In one preferred embodiment, the transmission is provided as a two-speed transmission, wherein two shifting positions are configured as forward gears, thus as a first and a second gear, or as a forward and reverse gear, a third shifting position which is configured as a neutral position being provided.

The transmission preferably has an actuator unit according to the invention as described above, wherein the actuator unit is configured for activating the transmission, in particular for setting at least two shifting positions in the transmission. The assembly alignment and/or the positioning of the transmission preferably engage/engages with the actuator unit, preferably with the assembly alignment and/or the positioning of the actuator unit. As a result, the transmission is advantageously easier to assemble and service, because the actuator unit can be removed or replaced, respectively, as a unit. As a result, assembling and servicing times can be significantly reduced. Furthermore, the risk of erroneous assembly can be prevented in that the housing of the actuator unit has an assembly alignment in relation to the transmission.

The transmission is preferably configured for an electrically driven vehicle, preferably for a commercial vehicle.

The transmission preferably has a transmission housing and is furthermore preferably configured for receiving the actuator unit at least partially, preferably completely, in the transmission housing.

The invention is not limited to the embodiments described above. Moreover, further embodiments can be achieved by combining, substituting or omitting individual features.

Preferred embodiments of the invention will be described hereunder by means of the appended drawings.

### BRIEF DESCRIPTION OF THE DRAWINGS

FIG. 1 shows a first embodiment of an actuator unit according to the invention; and

FIG. 2 shows a second embodiment of an actuator unit according to the invention.

### DETAILED DESCRIPTION OF THE DRAWINGS

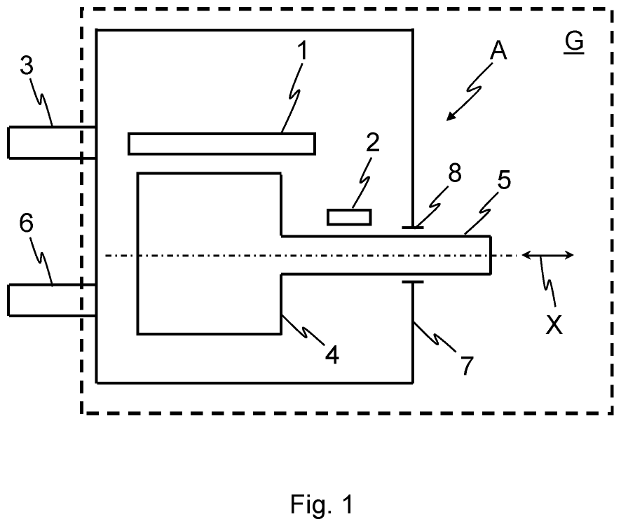

FIG. 1 shows a first embodiment of an actuator unit A according to the invention.

Shown is an actuator unit A which is provided within a transmission G, that is to say within a transmission housing of the transmission G.

The actuator unit A has a housing 7 which is configured for being provided within the transmission G, for example within the transmission housing. The housing 7 moreover is configured so as to be sealed in relation to the transmission G such that the actuator unit A can be provided as a separate unit within the transmission G.

The housing 7 has an opening 8 which is penetrated by an activation element 5. The activation element 5 here, by way of the end thereof that is on the right in the drawing, extends into the transmission G. The activation element 5 here is configured for engaging with at least one shifting element (not shown) of the transmission G so as to set at least two shifting positions in the transmission G.

The housing 7 of the actuator unit A contains an actuator 4 which is connected to the activation element 5. The actuator 4 is configured for displacing the activation element 5 parallel to an activation direction X.

The activation direction X here is configured as a straight line such that a displacement of the activation element 5 parallel to the activation direction X corresponds to a translatory displacement of the activation element 5. The housing 7 of the actuator unit A furthermore contains a detection unit 2 which is configured for detecting a position of the activation element 5 parallel to the activation direction X. As a result, it is possible for the position of the activation element 5 parallel to the activation direction X to be determined, as a result of which an indirect determination of the shifting position in the transmission G is moreover enabled, because the activation element 5 engages with a shifting element and the position of the latter can therefore be determined from the position of the activation element 5.

The housing 7 furthermore contains a control unit 1 which is configured for carrying out the controlling action of the actuator unit A. For this purpose, the control unit 1 is configured for actuating the actuator 4 so as to initiate a displacement of the activation element 5 parallel to the activation direction X. The control unit 1 is furthermore configured for receiving control signals of a superordinate entity, for example of a transmission control device.

The housing 7 of the actuator unit A furthermore has a signal interface 3 which is configured for receiving control signals of a higher entity, for example of a transmission control device, and for making said control signals available to the control unit 1. In the embodiment shown, the signal interface 3 penetrates the boundary of the transmission G, thus in particular the transmission housing of the transmission G. The signal interface 3 is furthermore configured for relaying status signals, for example a shifting position, to devices outside the transmission, for example to the transmission control device.

Furthermore shown is a power interface 6 which, like the signal interface 3, penetrates the transmission housing of the transmission G. The power interface 6 is configured for receiving power for the operation of the actuator unit A and for supplying said power to corresponding elements of the actuator unit A, in particular the control unit 1, the detection unit 2 and the actuator 4.

Both the signal interface 3 and the power interface 6 are configured for establishing a connection to elements outside the transmission G and for receiving signals or power, respectively, by way of said elements.

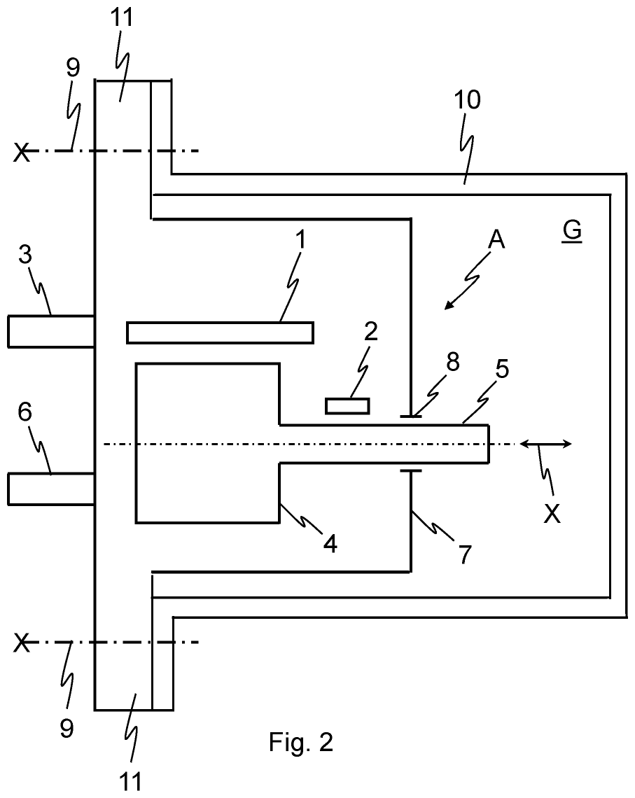

FIG. 2 shows a second embodiment of an actuator unit A according to the invention.

The construction of this actuator unit A is substantially identical to that of the actuator unit A from FIG. 1. There is however a difference in terms of the attachment to the transmission G.

The transmission G here is substantially indicated by a transmission housing 10 which is illustrated in a sectional view and is open toward the left. Further elements of the transmission G have not been illustrated for reasons of clarity. The actuator unit A is introduced into the transmission housing 10 from the left so that the activation element 5 is situated in the interior of the transmission G and is configured for setting at least two shifting positions.

The actuator unit A and the transmission housing 10 are configured for being fastened with fastening elements 9, for example with screws. As a result, the actuator unit A is fixed and positioned in relation to the transmission G. The actuator unit A has fastening portions 11 for fastening. The actuator unit A thus closes the left opening of the transmission housing 10.

The signal interface 3 and the power interface 6 of the actuator unit A are provided on the actuator unit A such that said signal interface 3 and said power interface 6 are positioned outside the transmission housing 10. As a result, these interfaces 3, 6 can readily contact further elements outside the transmission G without further openings having to be provided in the transmission housing 10.

It is understood that embodiments in which an opening for introducing the actuator unit A extends only across part of a housing width of the transmission G may also be provided.

The description hereunder of the functional mode of the actuator unit A and of special embodiments is given with reference to both figures, unless otherwise noted.

The functional mode of the actuator unit A is as follows.

When a control signal is transmitted to the actuator unit A by way of the signal interface 3, this control signal is processed in the control unit 1. The control unit 1, by way of the position of the activation element 5 detected by means of the detection unit 2, is configured for determining which shifting position currently prevails in the transmission G. If the prevailing shifting position (actual shifting position) does not correspond to the shifting position that has been transmitted to the control unit 1 by way of the control signal (nominal shifting position), the control unit 1 thus actuates the actuator 4 and as a result initiates a displacement of the activation element 5 parallel to the activation direction X. As a result, a new shifting position is set within the transmission G, and a gear, or a neutral position, respectively, is thus engaged.

The actuator unit A is thus configured as a separate and self-contained unit which as such can be installed in the transmission G. The housing 7 of the actuator unit A is configured for being fixed in the transmission G. To this end, possibilities for screw connections between the housing 7 and the transmission G are provided, for example.

The actuator unit A discussed here can be present in a wide variety of embodiments, which are to be explained in more detail hereunder.

For example, the actuator 4 can be configured as a fluidic actuator, in particular as a hydraulic or as a pneumatic actuator. In such an embodiment, the power interface 6 is configured for directing fluid, that is to say hydraulic liquid or compressed air, to the actuator 4 so as to by way thereof make available to said actuator 4 pressure and thus power for the operation of the actuator unit A.

In contrast, if the actuator 4 is of an electromechanical or electrical configuration, and is configured here in particular as an electric motor or as a magnetic mechanism, the power interface 6 is configured as an electrical interface which directs power in the form of an electric current for the operation of the actuator unit A to the actuator 4.

The control unit 1 can be configured as an electronic control means, in particular as a control apparatus, for example. In such a case, said electronic control unit is connected to the signal interface 3, in particular for receiving control signals, wherein the signal interface 3 is configured as an electronic interface, in particular as a data interface, by way of which control data, for example of a vehicle in which the transmission G is provided, can be transmitted to the actuator unit A and thus to the control unit 1.

A further embodiment of the invention does not have a control unit 1 within the housing 7. The control unit 1 here is provided outside the housing 7, wherein said control unit 1 is attached to the housing 7, for example. The control unit 1 can however also be provided so as to be remote from the housing 7, wherein a connection between the signal interface 3 and the control unit 1 for enabling the control of the actuator unit A, in particular of the actuator 4, on the one hand, and the reception of data, in particular by the detection unit 2, on the other hand, is provided.

Furthermore, the detection unit 2 can be configured as an electronic sensor, for example. Signals which correspond to the position of the activation element 5 parallel to the activation direction X can in this instance be made available to an electronic control unit 1 by way of a data connection. Alternatively, the detection unit 2 can however also be of a mechanical or electromechanical configuration. A displacement of the activation element 5 parallel to the activation direction X can initiate a mechanical effect, for example a rotating movement, in the detection unit 2, for example, said rotating movement being able to be electronically detected and added up as an angular sum, for example, and thus being able to be transmitted to the control unit 1 for determining the position of the activation element 5 parallel to the activation direction X.

In the embodiment shown, the signal interface 3 and the power interface 6 are illustrated such that said signal interface 3 and said power interface 6 penetrate the boundary of the transmission G, thus in particular the transmission housing of the transmission G. In another embodiment, at least one of these interfaces 3, 6 can however also be configured such that said interface is situated only within the transmission G. The transmission G here is configured for supplying the corresponding interface 3, 6 in a corresponding manner.

In the case of a fluidic configuration of the actuator 4, actuating members, in particular solenoid valves, are provided for regulating the fluid flow, for example. Said actuating members in this instance are for example likewise provided within the actuator unit A, in particular within the housing 7, such that the character of the actuator unit A as a self-contained component is not compromised. These actuating members are configured for actuation by the control unit 1, for example. In this way, the control unit 1 is capable of controlling the fluid flow and of correspondingly activating the actuator 4.

In the embodiment shown, the activation element 5 is configured as a rod which, proceeding from the actuator 4, extends toward the right through the opening 8 into the transmission G. A displacement of the activation element 5 parallel to the activation direction X here is provided as a translatory displacement which takes place along a rod axis. However, embodiments in which for example the activation element 5 is not configured as a rod which is configured so as to be displaceable along the rod axis thereof can however also be provided. For example, a pivotable activation element 5 can be provided. Moreover, the activation direction X does not have to correspond to a straight line; for example, the activation element 5 can also be configured for carrying out a circular movement or any other type of movement upon activation.

The opening 8, conjointly with the activation element 5, can be configured so as to be sealed in relation to the transmission G such that here in particular no oil or wear debris from the transmission G can penetrate into the housing 7 of the actuator unit A.

In the embodiment from FIG. 2, the actuator unit A can be embodied so as to be sealed in relation to the transmission housing 10. To this end, a seal can be provided on a region of the actuator unit A, for example on a fastening portion 11, which contacts the transmission housing 10, for example. A reliable closure of the transmission housing 10 in relation to external influences, such as dirt or dust, is thus ensured.

### LIST OF REFERENCE SIGNS

1 Control means
2 Detection means
3 Signal interface
4 Actuator
5 Activation element
6 Power interface
7 Housing
8 Opening
9 Fastening element
10 Transmission housing
11 Fastening portion
A Actuator unit
G Transmission
X Activation direction

1.-17. (canceled)

18. An actuator unit for a shiftable transmission of an electrically driven commercial vehicle, comprising:
an activation element which is configured for setting at least two shifting positions in the transmission, wherein
the actuator unit is configured for being provided at least in part as a separate unit within the transmission.

19. The actuator unit as claimed in claim 18, wherein at least one of:
the activation element for setting the at least two shifting positions is configured for engaging with at least one shifting element of the transmission, or
the activation element is configured for being displaced parallel to an activation direction.

20. The actuator unit as claimed in claim 19, wherein
the activation element is configured so as to be integral to the at least one shifting element.

21. The actuator unit as claimed in claim 18, further comprising:
a housing configured for being provided in or on the transmission.

22. The actuator unit as claimed in claim 18, further comprising:
an actuator configured for displacing the activation element parallel to the activation direction.

23. The actuator unit as claimed in claim 22, wherein
the actuator is configured as a pneumatic, hydraulic, electromechanical or motorized actuator.

24. The actuator unit as claimed in claim 23, wherein
in a pneumatic or hydraulic configuration of the actuator, actuating members which are configured for activating the actuator are provided in the actuator unit.

25. The actuator unit as claimed in claim 18, further comprising:
at least one control unit configured for controlling the actuator unit, and/or
at least one detection unit configured for detecting a position of the activation element along the activation direction.

26. The actuator unit as claimed in claim 25, wherein
the at least one control unit is configured as an electronic control unit, or wherein the at least one detection unit is configured as a path sensor.

27. The actuator unit as claimed in claim 25, wherein
the at least one control unit and the at least one detection unit are integrally configured.

28. The actuator unit as claimed in claim 18, further comprising:
at least one signal interface configured for receiving a control signal and/or emitting a status signal, and/or
at least one power interface configured for receiving power for operation of the actuator unit.

29. The actuator unit as claimed in claim 28, wherein at least one of:
the at least one signal interface for receiving the control signal is configured for establishing a connection to an element outside a housing of the transmission, or
the at least one power interface for receiving the power is configured for establishing a connection to an element outside the housing of the transmission.

30. The actuator unit as claimed in claim 19, wherein
the activation direction is configured as a straight line or as a circular path.

31. The actuator unit as claimed in claim 18, wherein
a housing of the actuator unit, in relation to the transmission, has an assembly alignment and/or positioning which is configured for engaging in a complementary manner with an assembly alignment and/or positioning of the transmission.

32. A transmission, comprising:
an assembly portion configured for assembling an actuator unit, wherein
the assembly portion has an assembly alignment and/or positioning in relation to the actuator unit,
the transmission has at least two shifting positions, and
the actuator unit comprises:
an activation element which is configured for setting the at least two shifting positions in the transmission, wherein
the actuator unit is configured for being provided at least in part as a separate unit within the transmission.

33. A transmission, comprising:
an actuator unit as claimed in claim 18, wherein
the actuator unit is configured for setting the at least two shifting positions in the transmission, and
the actuator unit engages with an assembly alignment and/or positioning of the transmission.

34. The transmission as claimed in claim 32, wherein
the transmission is configured for an electrically driven commercial vehicle.
